(19) United States
(12) Patent Application Publication
(10) Pub. No.: US 2004/0126039 A1
(43) Pub. Date: Jul. 1, 2004

(54) Cylindrical-shaped bearing for reciprocatory sliding

(75) Inventors: Kotaro Kashiyama, Inuyama-Shi (JP); Hajime Kachi, Inuyama-Shi (JP); Takahiro Niwa, Inuyama-Shi (JP)

Correspondence Address: RADER, FISHMAN & GRAUER PLLC, 39533 WOODWARD AVENUE, SUITE 140, BLOOMFIELD HILLS, MI, 48304-0610, US

(73) Assignee: Daido Metal Company Ltd.

(21) Appl. No.: 10/712,070

(22) Filed: Nov. 13, 2003

(30) Foreign Application Priority Data
Dec. 27, 2002 (JP) 2002-379970

(51) Int. Cl. F16C 23/04; F16C 29/02

(52) U.S. Cl. 384/38

(57) ABSTRACT

In order to provide durable shock absorbers, a bearing to bear a piston rod is enhanced in wear resistance and made low in friction. A cylindrical-shaped bearing for reciprocatory sliding, to bear a piston rod comprises lengthy inclined portions and a short parallel portion on an inner-peripheral surface of the bearing.

### CROSS-REFERENCE TO RELATED APPLICATIONS

This application claims priority based on Japanese Patent Application No. 2002-379970, filed Dec. 27, 2002, the entirety of which is incorporated herein by reference.

### BACKGROUND OF THE INVENTION

The present invention relates to a cylindrical-shaped bearing for supporting a reciprocating shaft, for example, a piston rod of a shock absorber for damping of a shock load in automobiles, industrial machinery or the like.

Automobiles, two-wheelers or the like have spread worldwide, which correspondingly demands various performances such as safety, comfortableness, stillness or the like. Also, an improvement achieved in engines generally and widely leads to enhancement lengthening of travel distance and in durability in body structure now.

For example, in order to improve a ride feeling, shock absorbers are provided between a body and wheels in an automobile. Such shock absorbers are of a known hydraulic-type construction such that a piston having an orifice is arranged in a cylinder, the cylinder being mounted on, for example, a wheel side and a piston rod being mounted on a body side. Such shock absorbers are normally mounted with an axial direction thereof inclined relative to a direction, in which wheels and a body reciprocate, so that there is caused a state, in which the piston rod is supported on an extremely small area of a bearing. When such state of extremely small area support continues, the bearing will wear early. In order to cope with this, for example, a material for forming bearings has been improved. Since there are limits to such improvement of the material, however, an improvement has been also demanded in terms of a structure.

In complying with such demand, there has been proposed a bush provided in a bearing for bearing a piston rod in, for example, shock absorbers, in which bush end inner-peripheral surfaces extending from ends of the bush to a bearing surface for bearing the rod are defined by a plurality of inclined surfaces such that an angle relative to a central axis of the bearing gradually decreases toward the bearing surface from the ends (see, for example, JP-A-11-270556 (paragraph numerals “0007”-“0011”, FIG. 1).

With the constitution described in the above prior art document, however, since both axially end portions of the inner-peripheral surface of the bearing form so-called inclined portions including a plurality of joined cone-shaped side surfaces or arcuate surfaces, both side portions of an equal-diameter portion (parallel portion) between the inclined portions on both ends, which are contiguous to the inclined portions, become locally high in surface pressure, so that wear increases in some cases.

### BRIEF SUMMARY OF THE INVENTION

The invention has been thought of in view of the above circumstances, and has its object to provide a cylindrical-shaped bearing for reciprocatory sliding, which eliminates a fear of occurrence of extremely small supporting area and locally high pressure surface area and is excellent in wear resistance.

According to the invention, a cylindrical-shaped bearing for supporting a reciprocating shaft, comprises, an inner peripheral surface for supporting thereon the reciprocating shaft, wherein the inner peripheral surface includes a first surface extending parallel to a central axis of the cylindrical-shaped bearing, and second and third tapered surfaces between which the first surface is arranged in a direction of the central axis and which are inclined with respect to the central axis in such a manner that diameters of the second and third tapered surfaces decrease gradually in respective axial directions away from respective axial ends of the inner peripheral surface toward the first surface.

As described above, an inner-peripheral surface of a bearing for bearing a piston rod in a shock absorber has a so-called crowning shape, and the inventors of the present application have earnestly studied about a cylindrical-shaped bearing for reciprocatory sliding, which possesses a more excellent wear resistance, in order to impart a further durability to shock absorbers, and found that an effect with excellent durability is obtained when inclined portions on both axial ends are lengthened and a central, parallel portion is shortened as compared with the prior art.

That is, when an axial length of the first surface is P and an axial length of the inner peripheral surface as a total amount of the axial length of the first surface and axial lengths of the second and third tapered surfaces is W, a relationship between P and W satisfies a formula of 0.5/W≦P/W≦⅓ (claim 2).

With this constitution, since the first surface centrally of the bearing is small in length, a shaft to be supported can be borne at a lengthy area (second and third tapered surfaces) when the shaft is inclined with respect to the bearing. That is, since the bearing supports the shaft in a large area, surface pressure is small to attack the bearing to a less degree, so that the bearing is made excellent in wear resistance.

Also, it is preferable that an angle between the central axis and each of the second and third tapered surfaces (or a tangential line of each of the second and third tapered surfaces) in a cross sectional view taken along an imaginary plane extending along the central axis is not less than 0.05 degree and not more than 5.0 degree.

Further, it is preferable for decreasing the surface pressure between the inner peripheral surface and shaft or increasing the support area therebetween that in the cross sectional view taken along the imaginary plane extending along the central axis, one of side surfaces (or a tangential line of the one of the side surfaces) of the second tapered surface and one of side surfaces (or a tangential line of the one of the side surfaces) of third tapered surface opposed to each other through the central axis is parallel to each other. It is preferable for preventing the surface pressure between the shaft and the inner peripheral surface from increasing locally (particularly, at a boundary between the first surface and at least one of the second and third tapered surfaces and/or at least one of axial ends of the inner peripheral surface) that a distance in a direction perpendicular to the ones of side surfaces opposed to each other through the central axis and parallel to each other (or the tangential lines of the ones of the side surfaces opposed to each other through the central axis and parallel to each other) between the ones of the side surfaces (or the tangential lines of the ones of the side surfaces opposed to each other through the central axis and parallel to each other) is not less than a diameter of the reciprocating shaft, over the whole axial lengths of the second and third tapered surfaces.

### BRIEF DESCRIPTION OF THE DRAWINGS

FIG. 1 is a partially cross sectional view taken along an imaginary plane extending along an central axis of a cylindrical bearing to show an embodiment of the invention with a bearing and a piston rod; and

FIG. 2 is a partially cross sectional view showing a shock absorber for automobiles in which the bearing of the invention is usable.

### DETAILED DESCRIPTION OF THE PREFERRED EMBODIMENT

An explanation will be given below to an embodiment of a bearing of the invention for bearing a piston rod of a shock absorber for automobiles, with reference to the drawings.

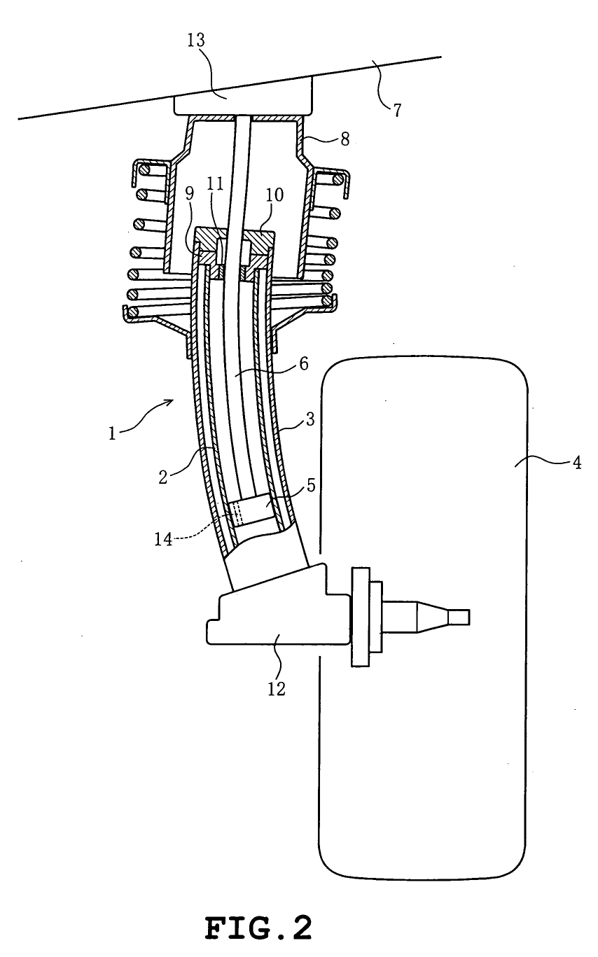

As shown in FIG. 2, a shock absorber 1 for automobiles is constructed such that an outer shell 3 receiving therein a cylinder 2 is connected at its lower end to a side of a wheel 4 through a connection 12 and a piston rod 6 of a piston 5 fitted slidably into the cylinder 2 is connected at its upper end to a side of a body 7 through a connection 13. In addition, an outer cylinder 8 covering an upper end of the outer shell 3 is mounted on the upper end of the piston rod 6.

A stepped guide member 9 is fittingly mounted in an upper portion of the outer shell 3, and the guide member 9 is compressively secured between the cylinder 2 and a cap 10 fixed by welding or the like to the upper end of the outer shell 3. A wrapped-bush type bearing 11 as a cylindrical-shaped bearing for reciprocatory sliding is mounted on an inner-periphery of the guide member 9, and the bearing 11 slidably supports the piston rod 6. In addition, in this mounting state, an axial direction of the shock absorber 1 is inclined relative to a direction, in which the wheel 4 and the body 7 reciprocate.

The bearing 11 is formed by winding a sheet material including a steel back plate and a bearing alloy material on the steel back plate into a cylindrical shape, and a slide surface (inner-peripheral surface) of the bearing alloy material is covered by a synthetic resin layer, in which PTFE (polytetrafluoroethylene) is added to and mixed with PFA (tetrafluoroethylene-perfluoro alkyl vinyl ether copolymer resin) of a main component of the synthetic resin layer. And the piston 5 is provided with an orifice 14, so that when the wheel 4 moves up and down due to traveling, or starting/stoppage of an automobile to generate a vertical mutual movement between the cylinder 2 and the piston 5, an oil filled in the cylinder 2 passes through the orifice 14 of the piston 5 to perform a damping action based on its viscous resistance and frictional resistances of various parts.

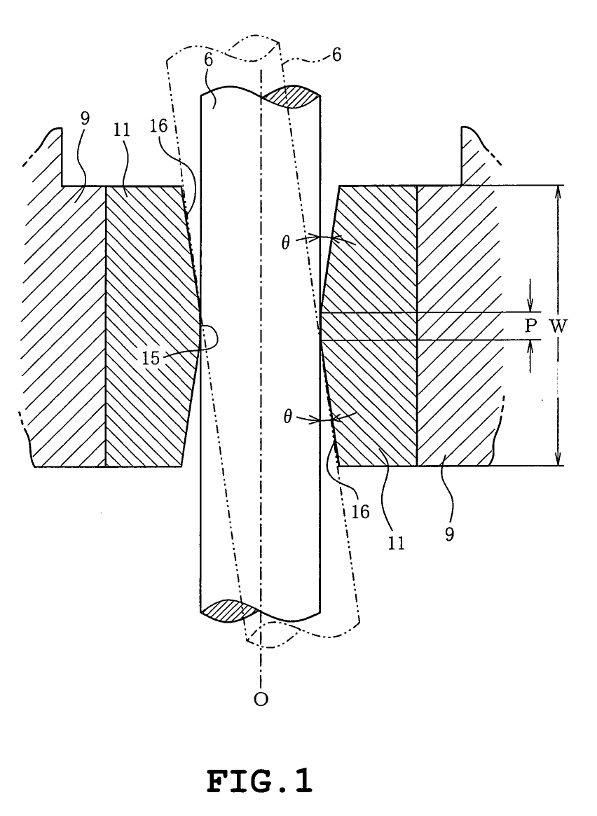

And as shown in FIG. 1 as an enlarged view of structural portions of the bearing 11 and the piston rod 6, an inner-peripheral surface of the bearing 11 comprises a parallel portion 15 on a central area thereof and inclined portions 16 extending from both axial end portions of the bearing 11 to the parallel portion 15. Here, the parallel portion 15 keeps its inner diameter constant in an axial direction, and the inclined portions 16 have respective inner diameters decreasing respectively from the axial end portions of the inner-peripheral surface to the parallel portion 15. Incidentally, in a cross sectional view taken along an imaginary plane extending along a central axis 0 of the bearing 11, the inclined portions 16 may be defined by straight lines inclined relative to the central axis O, or by internally projecting convex curves capable of supporting the piston rod 6 with a large support area between the piston rod 6 and each of the inclined portions 16 when the inner-peripheral surface of the bearing 11 is deformed to conform with an outer surface of the piston rod 6. The inclined portions 16 may be defined by both the straight lines and internally projecting convex curves in the cross sectional view.

The parallel portion 15 is set to be small in axial length while the inclined portions 16 are set to be large in axial length. More specifically, when the bearing 11 has an axial length W (mm) and the parallel portion 15 has a length P (mm), the length P of the parallel portion 15 is set in a range to meet 0.5/W≦P/W≦⅓. Also, when the inclined portions 16 have an inclination of θ degrees relative to the central axis O of the bearing 11, the inclination angle θ is set to meet 0.05 degree ≦θ≦5.0 degree. In addition, the inclination angle θ of the piston rod 6 is drawn largely with exaggeration in FIG. 1, although it is different from the reality.

Here, since the shock absorber 1 is mounted in an inclined attitude as shown in FIG. 2, the piston rod 6 is supported at edges of the bearing 11. And when the wheel 4 moves up and down relative to the body 7 as the automobile travels, the piston 5 reciprocates vertically in the cylinder 2 and the piston rod 6 correspondingly moves vertically while supported at the edges of the bearing 11.

In this case, the piston rod 6 is borne by a one-side half of an entire inner-peripheral surface of the inclined portion 16 above the central parallel portion 15 of the bearing 11 and by the other-side half of another entire inner-peripheral surface of the inclined portion 16 below the central parallel portion 15. Further, since the parallel portion 15 is small in length and the inclined portions 16 are large in length, a length of the piston rod 6 borne by the inclined portions 16 becomes large. Therefore, the surface pressure on the inclined portions 16 of the bearing 11 is small to maintain smooth reciprocatory sliding, thus resulting in low wear and low friction. Incidentally, the piston rod 6 borne at the edges of the bearing 11 is shown by two-dot chain lines in FIG. 1.

Also, although being small in length, the parallel portion 15 is formed at the central area of the bearing. Therefore, as the piston rod 6 reciprocates, a lubricating oil is drawn onto the parallel portion 15 to form wedge oil films on the parallel portion 15 and the inclined portions 16, so that the bearing 11 achieves low wear and low friction.

Tests were given to verify the above-mentioned effect of the invention. The verifying tests included a friction test for measuring friction (N) and an wear test for measuring wear loss (μm) of the bearing 11, performed when the bearing 11 and the piston rod 6 slid relative to each other. A value of the friction (N) was measured in a state in which the bearing 11 was assembled into a concerned shock absorber, and the wear loss (μm) was measured by a circularity meter. Test pieces included items 1 to 9 of the invention and items 1 to 3 for comparison, whose axial length W (mm) of the bearing 11, length P (mm) of the parallel portion 15, and inclination angle θ (degrees) of the inclined portions 16 relative to the central axis were set respectively to be different among the items, and TABLE 1 indicates respective results and conditions of the tests.

TABLE 1

| | | | | Friction | Wear loss |
|---|---|---|---|---|---|
| | W(mm) | P/W | θ (deg) | (N) | (μm) |
| Item of invention 1 | 15.0 | 0.033 | 1.19 | 93.1 | 25 |
| Item of invention 2 | 15.0 | 0.1 | 1.32 | 100.0 | 31 |
| Item of invention 3 | 15.0 | 0.15 | 2.45 | 98.0 | 29 |
| Item of invention 4 | 15.0 | 0.25 | 0.25 | 107.8 | 36 |
| Item of invention 5 | 15.0 | 0.333 | 0.86 | 109.8 | 33 |
| Item of invention 6 | 15.0 | 0.333 | 0.17 | 103.9 | 28 |
| Item of invention 7 | 15.0 | 0.333 | 1.72 | 96.0 | 30 |
| Item of invention 8 | 6.0 | 0.333 | 4.29 | 87.2 | 42 |
| Item of invention 9 | 30.0 | 0.017 | 0.06 | 105.8 | 19 |
| Item for comparison 1 | 15.0 | 0.01 | 0.58 | 147.0 | 73 |
| Item for comparison 2 | 15.0 | 0.5 | 1.15 | 139.2 | 62 |
| Item for comparison 3 | 15.0 | 1 | 0 | 142.1 | 80 |

conditions of wear test:

load: 1960N stroke: +25 mm frequency: 2.5 Hz

number of times: two million

temperature: 80° C. lubrication: SA oil

shaft material: steel with Cr plating

Rz: 1 μm or less bush size: θ20×W mm×t 1.5 mm

conditions of friction test:

load: 980N stroke: +5 mm

temperature: room temperature

lubrication: SA oil

shaft material: steel with Cr plating

Rz: 1 μm or less bush size: φ41×W mm×t 2.0 mm

From the results of tests, remarkably favorable results in both friction (N) and wear loss (μm) have been obtained by items 1 to 9 of invention as compared with items 1 to 3 for comparison.

In addition, the invention is not limited to the embodiment described above and shown in the drawings but susceptible to the following extension or modification.

Shock absorbers, to which the invention is applicable, are not limited to the use for automobiles.

A mating shaft or member to be borne by the cylindrical-shaped bearing for reciprocatory sliding according to the invention, is not specifically limitative but may be any one on which an offset load acts and which reciprocates with sliding, as well as the piston rod of the shock absorber.

What is claimed is:

1. A cylindrical-shaped bearing for supporting a reciprocating shaft, comprising,
an inner peripheral surface for supporting thereon the reciprocating shaft, wherein the inner peripheral surface includes a first surface extending parallel to a central axis of the cylindrical-shaped bearing, and second and third tapered surfaces between which the first surface is arranged in a direction of the central axis and which are inclined with respect to the central axis in such a manner that diameters of the second and third tapered surfaces decrease gradually in respective axial directions away from respective axial ends of the inner peripheral surface toward the first surface.

2. A cylindrical-shaped bearing according to claim 1, wherein when an axial length of the first surface is P and an axial length of the inner peripheral surface as a total amount of the axial length of the first surface and axial lengths of the second and third tapered surfaces is W, a relationship between P and W satisfies a formula of 0.5/W≦P/W<⅓.

3. A cylindrical-shaped bearing according to claim 1, wherein an angle between the central axis and each of the second and third tapered surfaces in a cross sectional view taken along an imaginary plane extending along the central axis is not less than 0.05 degree and not more than 5.0 degree.

4. A cylindrical-shaped bearing according to claim 1, wherein in a cross sectional view taken along an imaginary plane extending along the central axis, one of side surfaces of the second tapered surface and one of side surfaces of the third tapered surface opposed to each other through the central axis is parallel to each other.

5. A cylindrical-shaped bearing according to claim 4, wherein a distance between the ones of the side surfaces in a direction perpendicular to the ones of the side surfaces is not less than a diameter of the reciprocating shaft.

6. A cylindrical-shaped bearing according to claim 1, wherein in a cross sectional view taken along an imaginary plane extending along the central axis, a tangential line of one of side surfaces of the second tapered surface and a tangential line of one of side surfaces of the third tapered surface opposed to each other through the central axis is parallel to each other.

7. A cylindrical-shaped bearing according to claim 6, wherein a distance in a direction perpendicular to the tangential lines of the ones of the side surfaces parallel to each other between the tangential lines of the ones of the side surfaces is more than a diameter of the reciprocating shaft.
